(19) United States
(12) Patent Application Publication
(10) Pub. No.: US 2018/0107349 A1
(43) Pub. Date: Apr. 19, 2018

(54) CALCULATOR MEDIA PRESENTATION

(71) Applicant: Hewlett-Packard Development Company, L.P., Houston, TX (US)

(72) Inventors: Syed S. Azam, Tomball, TX (US); Raymond S. Banks, Houston, TX (US)

(21) Appl. No.: 15/567,604

(22) PCT Filed: May 29, 2015
(86) PCT No.: PCT/US2015/033329

§ 371 Date: Oct. 18, 2017

(51) Int. Cl. G06F 3/0482; G06F 15/02; H04R 1/02; G06F 3/0488

(52) U.S. Cl. CPC G06F 3/0482; G06F 3/04886; H04R 1/028; G06F 15/0225

(57) ABSTRACT

Examples associated with calculator media presentation are disclosed. One example includes a calculator including a display. The calculator also includes a memory storing media content associated with a calculator functionality. The calculator also includes a media presentation module to cause the media content to be presented to a user via the display in response to an interaction from the user.

### BACKGROUND

Calculators are used in classrooms throughout the world to teach mathematical concepts ranging from addition and subtraction to complex calculus and beyond to students. Calculators may include, for example, scientific, financial, graphing calculators, and so forth. Differing types of calculator may have different features, different numbers of keys, different keypad configurations, different components, different uses, and so forth.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates an example calculator, on which example systems, and methods, and equivalents, may operate.

FIG. 2 illustrates another example calculator, on which example systems and methods, and equivalents, may operate.

FIG. 3 illustrates another example calculator, on which example systems and methods, and equivalents, may operate.

FIG. 4 illustrates a block diagram of an example calculator associated with calculator media presentation.

FIG. 5 illustrates another block diagram of an example calculator associated with calculator media presentation.

FIG. 6 illustrates an example method associated with calculator media presentation.

FIG. 7 illustrates an example system associated with calculator media presentation.

FIG. 8 illustrates an example calculator in which example systems, and methods, and equivalents, may operate.

### DETAILED DESCRIPTION

Calculators, systems, methods, and equivalents associated with calculator media presentation are described. Calculators are specialized devices for performing computations, graphing, statistics, math concepts, and so forth. Calculators may be characterized by a display and keypad focused on assisting a user in completing mathematics related tasks. Though other tasks may be possible by, for example, programming a calculator, native functionality of the calculator may be primarily focused on assisting users with mathematics related challenges. Calculators are used both in industry for completing projects, in research as data loggers when attached to testing equipment, and in classrooms for teaching mathematical concepts that students will eventually use when they transition to industry or research.

While still remaining specialized devices, the capabilities of calculators have begun converging towards other computing resources. This is due to technologies becoming inexpensive enough to add to calculators without substantially effecting the cost of the calculator, and because computers themselves are becoming less expensive than specialized calculators. Consequently, calculators are benefiting from increased memory, faster processing, advanced electronic visual displays (e.g., liquid crystal displays, touch interactive displays), network access, and so forth.

However, learning to use calculators may involve resources external to the calculator (e.g., a manual, a YouTube video, a teacher). Therefore, it may be desirable to leverage the new features in some calculators to deliver training directly to users of the calculators. This may be achieved by, for example, storing media files within calculators. The media files may be, for example, manuals explaining calculator functionality. As used herein, manuals refer to media files that facilitate training calculator users on how to operate the calculator itself. Consequently, a manual may explain features, expected inputs, expected outputs, provide examples, and so forth, in a manner that facilitates using various functions of a calculator. Further, because of the use of calculators within education, the media files may alternatively be subject matter tutorials that teach calculator users mathematical concepts that underlie the capabilities of the calculators. As used herein, subject matter tutorials refer to media files that facilitate teaching mathematical concepts to, for example, students using the calculator, though non-students may also be able to take advantage of subject matter tutorials. Subject matter tutorials may cover concepts ranging from basic arithmetic to complex calculus and beyond, and may or may not be related to actual functions suited for use with the calculator.

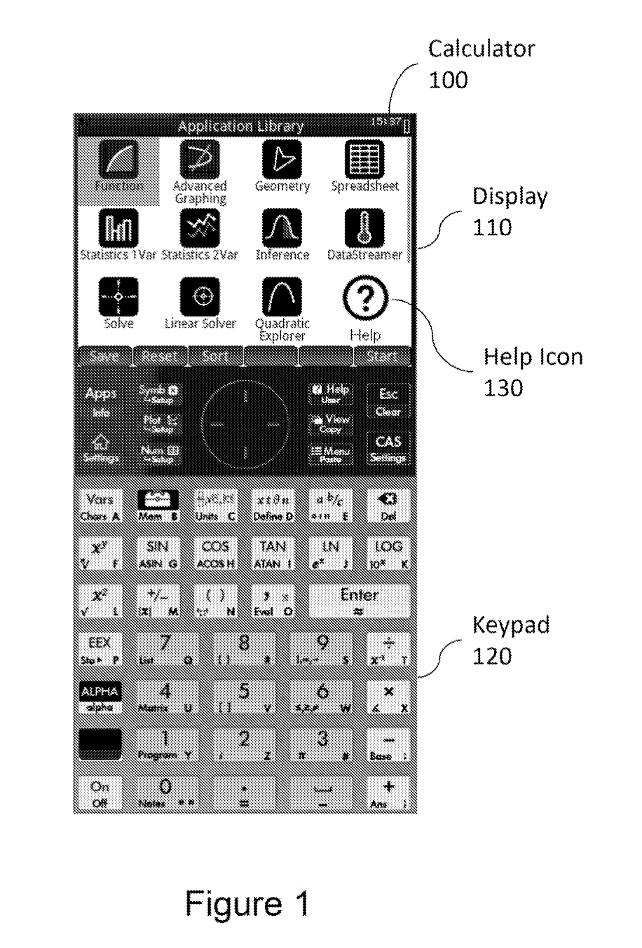

FIGS. 1, 2, and 3 illustrate example calculators on which example systems and methods, and equivalents, may operate. It should be appreciated that the items depicted in FIGS. 1, 2, and 3 are illustrative examples based on the HP PRIME calculator and many different features and implementations are possible.

FIG. 1 illustrates an example calculator 100. The calculator includes a display 110. In this example, display 110 is showing a menu of features available in calculator 100. In various examples, display 110 may be a touch interactive display, allowing users to interact with calculator 100 by touching various portions of display 110 to cause calculator 100 to perform various actions.

Calculator 100 also includes a keypad 120. Keypad 120 may be the primary interface for interacting with calculator 100. When display 110 is a touch interactive display, some interactions with calculator 100 may be achieved by interacting either with display 110 or with keypad 120. By way of illustration, a user could select the “inference” icon shown on display 110 by touching the icon with their finger, navigating to the icon using a directional pad on keypad 120, and so forth.

As mentioned above, calculator 100 may include stored media files associated with calculator functionalities. In this example, the media files may be accessible via help icon 130. Thus, a user seeking the media files may be able to access the files by navigating to help icon 130 (e.g., via an interaction with a touch interactive display, via keypad 120). When the user accesses help icon 130, a listing of media files may be presented to the user.

In various examples, the media files may be, for example, video files, audio files, a combination, and so forth. Thus, when the media files include video, the video portions may be presented to users via display 110. When the media files include audio, the audio portions may be played to users via speakers on the calculator (not shown). Alternatively, an audio jack or other connector (e.g., universal serial bus connector), may be used to play audio portions of the media files via headphones, external speakers, and so forth. In some examples, the media files may trigger calculator operations. Thus, a media file may be an embedded series of instructions that cause the calculator to go through a series of operations that serve as, for example, a manual explaining a calculator functionality, a subject matter tutorial related to a calculator functionality, and so forth. Media files may also include instructions for a calculator user to take to walk the user through performing a calculator function. Consequently, media files may be specifically tailored to the calculator in question to best teach users of the calculator how to use calculator functions and/or the concepts underlying the functions. In other cases, text may overlay the calculator operations, audio may accompany the calculator operations, and so forth. Audio instruction, may include, for example, descriptions of key presses that cause the calculator to take some action.

In some examples, accessing help icon 130 may cause certain media files to be recommended to the user. The recommendations may be based on calculator functionalities recently accessed by the user. By way of illustration, if a user access parabolic graphing features of calculator 100, after navigating to help icon 130, the user may be presented with video content related to parabolic graphing. If calculator 100 stores subject matter tutorials, the user may be recommended a media file that explains how to take an equation and graph the parabola. If calculator 100 stores manuals explaining calculator functionalities, the user may be recommended a media file that explains how to use calculator 100 to graph parabolas. In some examples, calculator 100 may store both manuals and subject matter tutorials, in which case both may be presented to a user accessing help icon 130. Recommendations may also be made, for example, based on prior user selections, input from an external source (e.g., teacher, curriculum), a preferred media file source (e.g., company, teacher), and so forth. In some examples, media files may be automatically presented to users under certain circumstances.

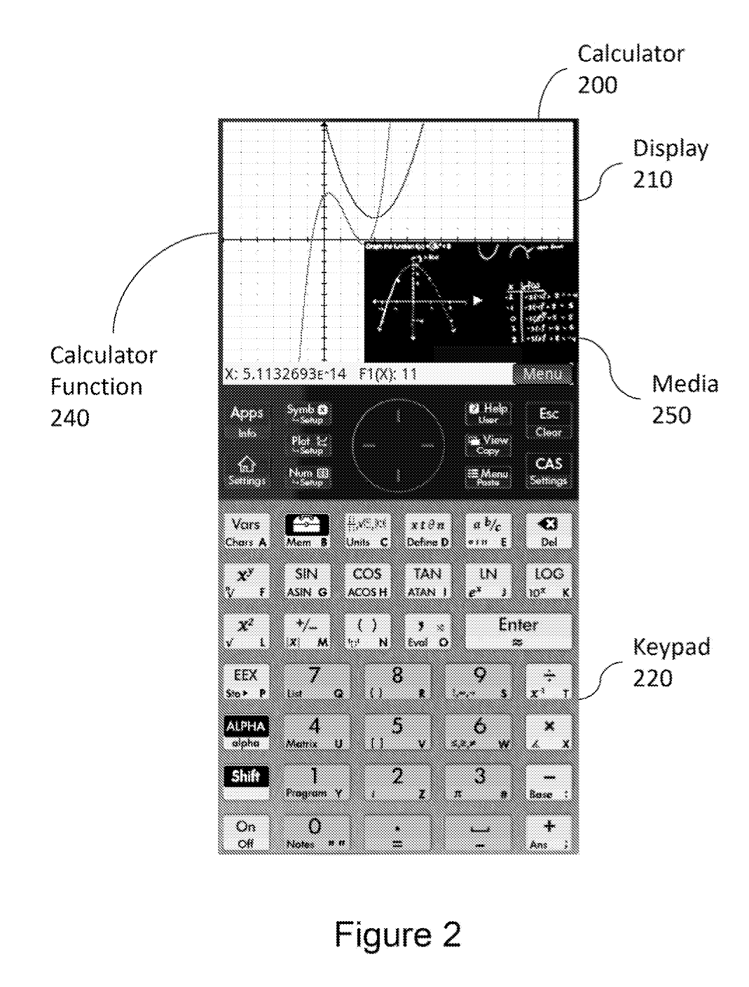

FIG. 2 illustrates another example calculator 200. Calculator 200 includes several example items similar to those described above with reference to calculator 100 (FIG. 1). For example, calculator 200 includes a display 210, and a keypad 220. Calculator 200 is illustrated as in being the process of presenting a media file 250 to a user via display 210. Further, in this example, media 250 is illustrated as overlaying a calculator function 240. In this example, media 250 is a video file that explains how to construct parabolas by hand from an equation, which is related to the calculator function currently being illustrated. Thus a user reviewing media 250 may be able to see how the media relates to the calculator function 250.

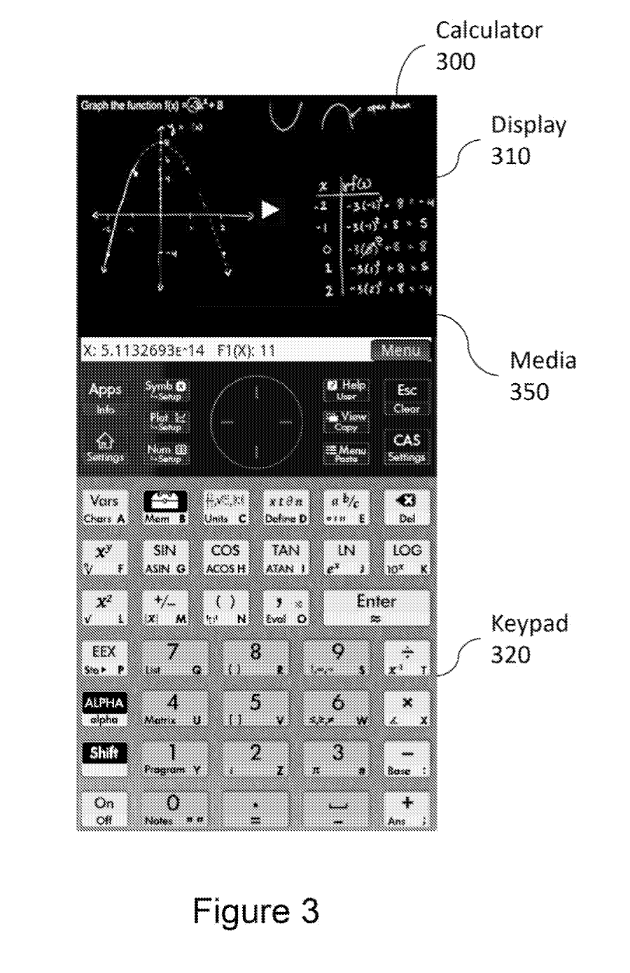

FIG. 3 illustrates another example calculator 300. Calculator 300 includes several example items similar to those described above with reference to calculator 100 (FIG. 1). For example, calculator 300 includes a display 310, and a keypad 220. Similar to calculator 200 (FIG. 2), calculator 300 is illustrated as in the process of presenting a media file 350 via display 310. In this example the media file 350 is taking up the entirety of display 310. A decision as to whether to overlay the entirety of display 310 as illustrated in FIG. 3, or a portion of the display 210 as illustrated in FIG. 210 may depend on, for example, a user setting, a type of media file being presented (e.g., subject matter tutorial, manual explaining calculator functionality), and so forth.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

“Module”, as used herein, includes but is not limited to hardware, firmware, software stored on a computer-readable medium or in execution on a machine, and/or combinations of each to perform a function(s) or an action(s), and/or to cause a function or action from another module, method, and/or system. A module may include a software controlled microprocessor, a discrete module, an analog circuit, a digital circuit, a programmed module device, a memory device containing instructions, and so on. Modules may include one or more gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

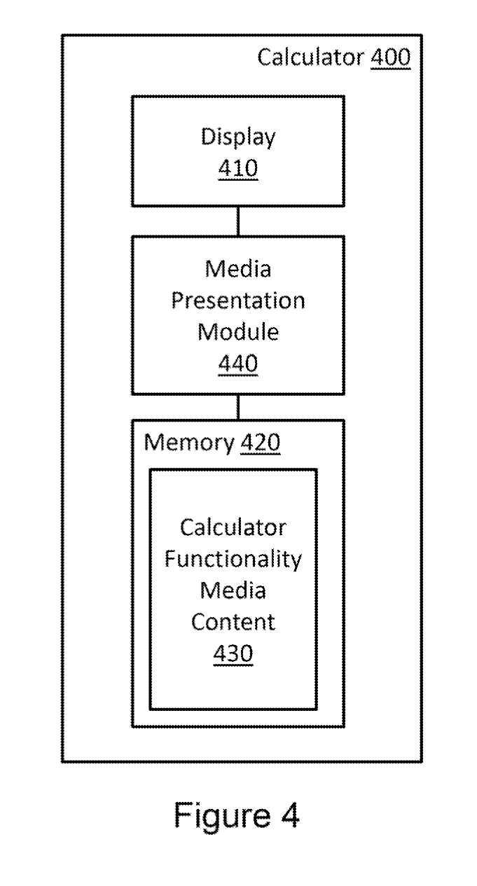

FIG. 4 illustrates an example calculator 400. Calculator 400 may be, for example, a graphing calculator, a scientific calculator, and so forth. Calculator 400 includes a display 410. In addition to the components shown, calculator 400 may also include a processor, a keypad, a power source (e.g., batteries, solar power), and so forth. As described above, different calculators may have different specifications and features.

Calculator 400 also includes a memory 420. Memory 420 may store media content 430 associated with calculator functionality. In various examples, media content 430 may serve as a calculator manual explaining the calculator functionality. Thus, a user accessing this type of media content 430 may seek instruction on how to use the calculator to solve problems associated with the calculator functionality. In another example, media 430 content may serve as a subject matter tutorial related to the calculator functionality. Thus, the subject matter tutorial may allow the user to learn mathematical concepts related to the calculator functionality.

Calculator 400 also includes a media presentation module 440. Media presentation module 440 may cause media content 430 to be presented to a user via display 410. Media content 430 may be presented to the user in response to an interaction from the user. The interaction from the user, may be, for example, a selection of media content 430 via, for example, a keypad, display 410, and so forth.

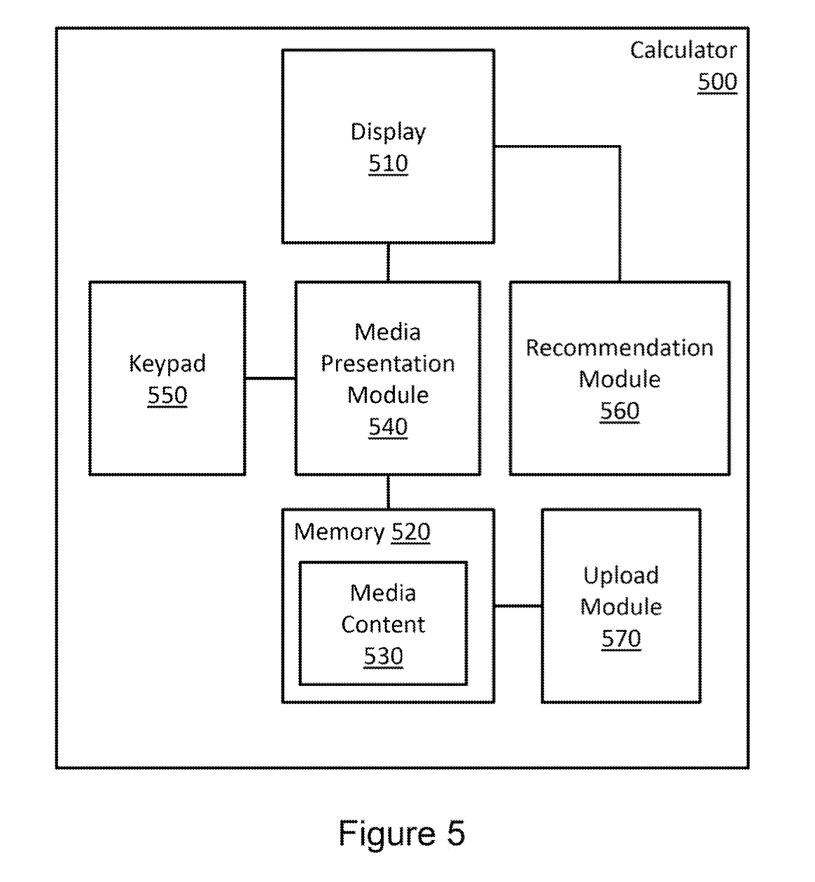

FIG. 5 illustrates a calculator 500. Calculator 500 includes several items similar to those described above with reference to calculator 400 (FIG. 4). For example, calculator 500 includes a display 510, a memory 520 storing a media content 530 associated with a calculator functionality, and a media presentation module 540 to present media content 530 to a user via display 510 in response to a user interaction.

Calculator 500 also includes a keypad 550. In various examples, the user interaction causing media presentation module 540 to be presented to the user via display 510 may be received via keypad 550. In other examples, display 510, may be a touch interactive display. When display 510 is a touch interactive display, the user interaction may be received via display 510. Other methods of interacting with calculator 500 may also be possible.

Calculator 500 also includes a recommendation module 560. Recommendation module 560 may recommend to the user, media content related to recent calculator operations initiated by the user. The media content related to recent calculator operations may be recommended via the display. In various examples, recommendation module 560 may operate after the user interacts with calculator 500 (e.g., via keypad 550, a touch interactive display 510) in a manner that indicates the user seeks information regarding a calculator functionality (e.g., by accessing a “help” application). Subsequently, recommendation module 560 may identify recent calculator operations initiated by the user and suggest media content (e.g., media content 530) related to these calculator operations. When calculator 500 includes media files that serve as manuals describing calculator functionality, recommendation module 560 may also recommend media files based on misused calculator operations.

Calculator 500 also includes an upload module 570. Upload module 570 may obtain media content 530 from an external source and store media content 530 in memory 520. The external source may be, for example, an external memory (e.g., external hard disc), a computer, a server accessed over the Internet, and so forth. The external source may be accessed via, for example, a wireless connection, a wired connection, and so forth. Using upload module 570 to store media content 530 may facilitate periodically changing the media content 530 stored on calculator 500 which may be desirable to, for example, update media content 530 to a newer version, replace media content 530 in memory 520 due to a limited size of memory 520, and so forth. In some examples, media content 530 may adhere to a curriculum of concepts that may be reviewed in series by a user of calculator 500. Consequently, upload module 570 may facilitate storing media files relevant to the learning of a user and may be changed over time based on, for example, concepts the user is learning, concept the user has mastered, concepts the user is struggling with, and so forth.

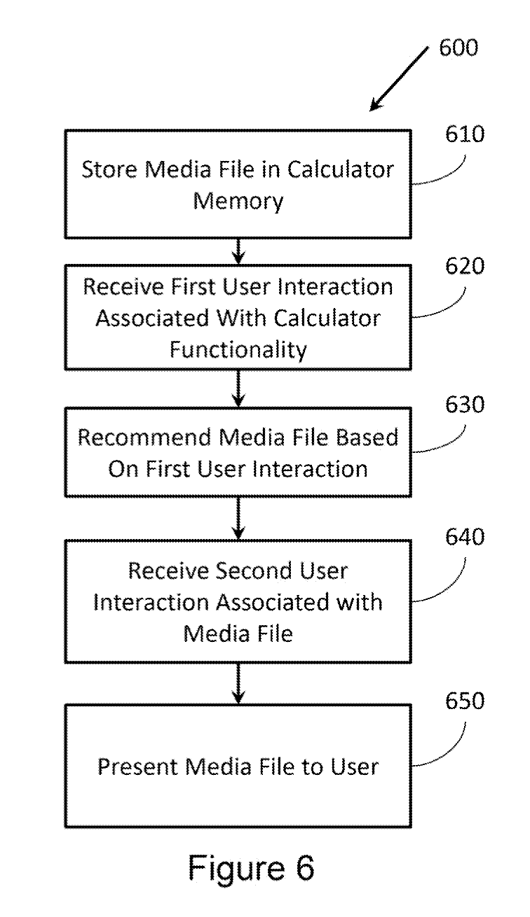

FIG. 6 illustrates an example method 600 associated with calculator media presentation. Method 600 may be embodied on a non-transitory processor-readable medium storing processor-executable instructions embedded within a calculator (e.g., calculator 500). The instructions, when executed by a processor, may cause the processor to perform method 600. In other examples, method 600 may exist within logic gates and/or RAM of an application specific integrated circuit (ASIC) embedded within a calculator.

Method 600 includes storing a media file associated with calculator functionality at 610. The media file may be stored in the memory of a calculator. The media file may be, for example, a subject matter tutorial related to the calculator functionality, a manual explaining the calculator functionality, and so forth. In various examples, the media file may be, a video file, an audio file, and so forth.

Method 600 also includes receiving a first interaction associated with the calculator functionality at 620. The first interaction may be received from a user. The first interaction may be the user attempting to access the calculator functionality via, for example, a keypad of the calculator, a touch interactive display of the calculator, and so forth.

Method 600 also includes recommending the media file to the user at 630. The media file may be recommended to the user based on the first user interaction. The media file may be recommended based on the calculator function accessed by the user at 620. By way of illustration, if the user attempted to access a trigonometric function, a media file associated with that trigonometric function may be recommended to the user at 630.

Method 600 also includes receiving a second user interaction at 640. The second user interaction may be associated with the media file. As before, the second user interaction may be received from the user via a keypad, a touch interactive display, and so forth.

Method 600 also includes presenting the media file to the user at 650. The media file may be presented to the user via the calculator. Depending on the what type (e.g., video, audio) of file the media file is, the media file may be presented via, for example, a display of the calculator, a speaker of the calculator, a combination of a display and a speaker, and/or via other calculator components. How the media file is presented may also depend on specifications of the calculator. For example, a calculator with an audio port may be able to present audio associated with a video or an audio file via headphones, external speakers, and so forth.

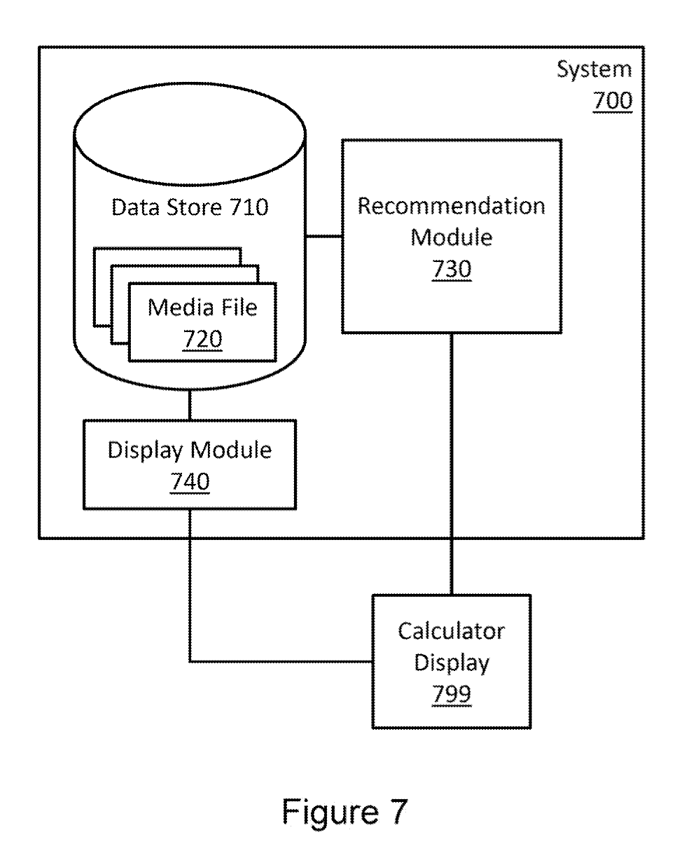

FIG. 7 illustrates a system 700, associated with calculator media presentation. System 700 includes a data store 710. Data store 710, as well as other components of system 700 may reside within a calculator. Data store 710 may store a set of media files 720 associated with a set of calculator functionalities. As described above, media files 720 may include, for example, subject matter tutorials related to the set of calculator functionalities, manuals explaining the set of calculator functionalities, and so forth.

System 700 also includes a recommendation module 730. Recommendation module 730 may monitor calculator functionalities accessed by a user. Recommendation module 730 may also recommend media files 720 to the user. Media files 720 may be recommended to the user via a display 799 of the calculator. Media files 720 may be recommended to the user based on calculator functionalities recently accessed by the user.

System 700 also includes a display module 740. Display module 740 may cause media files 720 to be presented to the user. Display module 740 may cause the media files to be presented to the user via calculator display 799. Display module 740 may cause the media files to be presented to the user in response to the user selecting the media file (e.g., via a graphical user interface). Consequently, the user selection of the media file may be received via, for example, a keypad of the calculator (not shown), a touch sensitive display (e.g., display 799) of the calculator, and so forth.

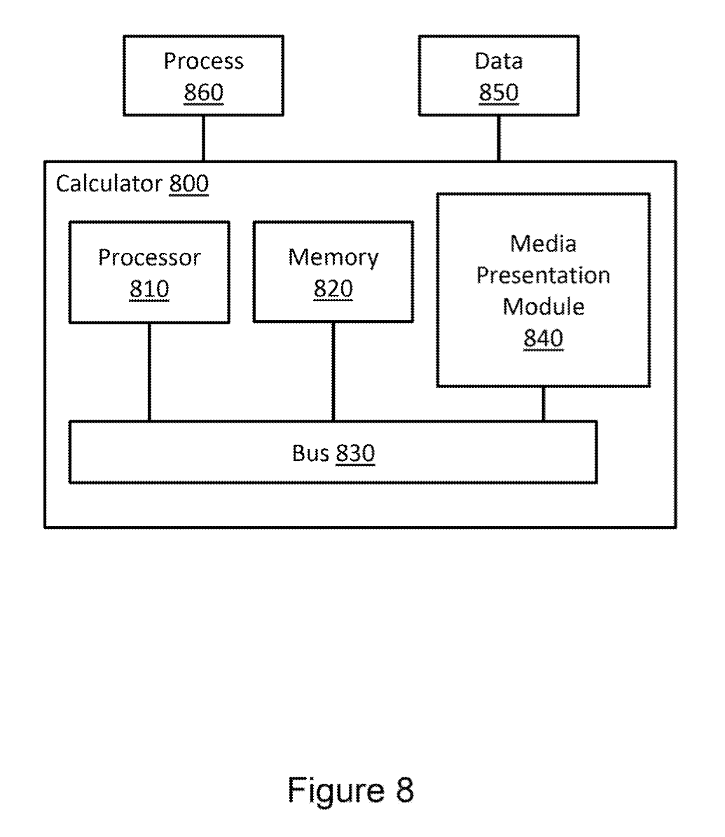

FIG. 8 illustrates an example calculator device in which example systems and methods, and equivalents, may operate. The example calculator device may be a calculator 800 that includes a processor 810 and a memory 820 connected by a bus 830. The calculator 800 includes a calculator media presentation module 840. Calculator media presentation module 840 may perform, alone or in combination, various functions described above with reference to the example systems, methods, apparatuses, and so forth. In different examples, calculator media presentation module 840 may be implemented as a non-transitory processor-readable medium storing processor-executable instructions, in hardware, software, firmware, an application specific integrated circuit, and/or combinations thereof.

The instructions may also be presented to calculator 800 as data 850 and/or process 860 that are temporarily stored in memory 820 and then executed by processor 810. The processor 810 may be a variety of various processors including dual microprocessor and other multi-processor architectures. Memory 820 may include non-volatile memory (e.g., read only memory) and/or volatile memory (e.g., random access memory). Thus, memory 820 may store process 860 and/or data 850. Calculator 800 may also be associated with other devices including other calculators, computers, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A calculator, comprising:
a display;
a memory storing media content associated with a calculator functionality; and
a media presentation module to cause the media content to be presented to via the display in response to an interaction.

2. The calculator of claim 1, further comprising a recommendation module to recommend, via the display, media content related to recent calculator operations.

3. The calculator of claim 1, further comprising a keypad and where the interaction is received via the keypad.

4. The calculator of claim 1, where the display is a touch interactive display and where interaction is received via the display.

5. The calculator of claim 1, where the media content serves as a manual explaining the calculator functionality.

6. The calculator of claim 1, where the media content serves as a subject matter tutorial, the subject matter tutorial related to the calculator functionality.

7. The calculator of claim 1, further comprising an upload module to obtain the media content from an external source and to store the media content in the memory.

8. The calculator of claim 1, where the calculator is a graphing calculator.

9. A method, comprising:
storing, in a memory of a calculator, a media file associated with a calculator functionality;
receiving, from a user, a first user interaction associated with the calculator functionality;
recommending the media file to the user based on the first user interaction;
receiving, a second user interaction associated with the media file; and
presenting the media file to the user via the calculator.

10. The method of claim 9, where the media file is one of, a subject matter tutorial related to the calculator functionality, and a manual explaining the calculator functionality.

11. The method of claim 9, where the media file is one of a video file and an audio file.

12. The method of claim 9, where the media file is presented to the user via of a display of the calculator, and a speaker of the calculator.

13. A system, comprising:
a data store in a calculator to store a set of media files associated with a set of calculator functionalities;
a recommendation module to monitor calculator functionalities accessed by a user and to recommend, via a display of the calculator, media files to the user based on recently accessed calculator functionalities; and
a display module to cause a media file to be presented to the user via the display in response to the user selecting the media file.

14. The system of claim 13, where the media files include one of, subject matter tutorials related to the set of calculator functionalities, and manuals explaining the set of calculator functionalities.

15. The system of claim 13, where the user selection of the media file is received via one of a keypad of the calculator and a touch sensitive display of the calculator.
